(19) United States
(12) Patent Application Publication
(10) Pub. No.: US 2022/0358897 A1
(43) Pub. Date: Nov. 10, 2022

(54) DISPLAY CONTROL APPARATUS, ELECTRONIC APPARATUS, RECORDING MEDIUM, AND DISPLAY CONTROL METHOD

(71) Applicant: SHARP KABUSHIKI KAISHA, Osaka (JP)

(72) Inventor: YUICHI SATO, Osaka (JP)

(21) Appl. No.: 17/721,902

(22) Filed: Apr. 15, 2022

(30) Foreign Application Priority Data
May 7, 2021 (JP) 2021-079366

(51) Int. Cl. G09G 5/10; G09G 3/3291

(52) U.S. Cl. CPC G09G 5/10; G09G 3/3291; G09G 2320/064; G09G 2340/0428

(57) ABSTRACT

A host controller in a display apparatus incudes a group determiner that determines an application as a determination factor, a drive setter that identifies a set that includes an upper-limit refresh rate, a lower-limit refresh rate, and a duty ratio of light emission and is set in response to the determination factor, and a drive controller that controls driving of the display apparatus in accordance with the identified set.

### BACKGROUND

### 1. Field

The present disclosure relates to a display control apparatus, an electronic apparatus, a recording medium, and a display control method.

### 2. Description of the Related Art

A typical electro-optical element forming each of pixels arranged in a matrix is a current-drive type, light-emitting organic electroluminescent (EL) element. Large-size and flat-panel displays featuring vividness of images have recently drawn attention and organic EL displays including organic EL elements as pixels have been widely developed.

The current-drive type electro-optical element is typically arranged on each pixel together with a switching element, such as a thin-film transistor (TFT), individually controlling the electro-optical element. An active-matrix display controlling the electro-optical elements on a per pixel basis thus results. The active-matrix display may display a higher definition video than a passive display.

The active-matrix display includes a connection line horizontally extending on a per row basis, and a data line and power line vertically extending on a per column basis. Each pixel includes an electro-optical element, connection transistor, drive transistor, and capacitor. A voltage applied to the connection line causes the connection transistor to turn on, and a data voltage (data signal) on the data line charges the capacitor, thus causing data to be written on the pixel. The data voltage charged on the capacitor turns the drive transistor on, allowing a current from the power line to flow to the electro-optical element. The pixel thus emits light.

If the active-matrix display forms a video by causing the pixels arranged on the active-matrix display to light in response to the data signal, the video may be displayed as described below. For example, one frame in which an image is formed with the connection lines vertically scanned once may be driven on a specific frequency. The video is thus displayed.

A typical method available to reduce display blur and afterimage in the active-matrix display is to drive the active-matrix display by false impulse driving. In the false impulse driving, out of the one frame, a non-light-emission period throughout which the active-matrix display does not emit light is set to be equal to or longer than a specific period of time. The one frame period is a period throughout which a video is displayed on the active-matrix display at a specific frame rate.

The false impulse driving has a lower display luminance than the hold driving and thus has a difficulty in ensuring visibility. If an attempt is made to achieve the same display luminance level in the false impulse driving as the hold driving, power consumption of the active-matrix display may increase. In the hold driving, the display continues to emit light throughout the one frame period.

As described above, the hold driving and the false impulse driving have their own respective problems. To address the problems of the hold driving and the false impulse driving, Japanese Unexamined Patent Application Publication No. 2006-333288 discloses a light-emitting apparatus that generates two pieces of moving image data different in frame rate. Specifically, the light-emitting apparatus disclosed in Japanese Unexamined Patent Application Publication No. 2006-333288 generates and outputs first video data displayed at a first frame rate and second video data displayed at a second frame rate. The light-emitting apparatus causes light-emitting elements at a light-emission duty ratio selected in response to the second frame rate.

The technique disclosed in Japanese Unexamined Patent Application Publication No. 2006-333288 addresses the problem of display blurring in the hold driving and the problem of flickering in the false impulse driving. The technique disclosed in Japanese Unexamined Patent Application Publication No. 2006-333288 has a difficulty in reducing an increase in power consumption of the light-emitting apparatus in the false impulse driving.

It is desirable to reduce power consumption of a display apparatus while maintaining display quality.

### SUMMARY

According to an aspect of the disclosure, there is provided a display control apparatus controlling a display apparatus having light-emitting elements. The display control apparatus includes: a drive setter that identifies a set that includes an upper-limit refresh rate, a lower-limit refresh rate, and a duty ratio of light emission and is in response to at least one determination factor selected from the group consisting of an application, an intensity of illumination, a remaining battery level, and an image content; and a drive controller that controls driving of the display apparatus in accordance with the identified set.

According to another aspect of the disclosure, there is provided a display control method controlling a display apparatus having light-emitting elements. The display control method includes: identifying a set that includes an upper-limit refresh rate, a lower-limit refresh rate, and a light emission duty ratio and is set in response to at least one determination factor selected from the group consisting of an application, an intensity of illumination, a remaining battery level, and an image content; and controlling driving of the display apparatus in accordance with the identified set.

### BRIEF DESCRIPTION OF THE DRAWINGS

FIG. 1 is a block diagram illustrating a configuration of a host controller in a display apparatus of an embodiment of the disclosure;

FIG. 2 is a block diagram illustrating a configuration of the display apparatus;

FIG. 3 illustrates an association table stored in the host controller and indicating an association between groups of applications and drive parameters;

FIG. 4 is a flowchart illustrating an example of a flow of driving control performed by the host controller in the display apparatus;

FIG. 5 illustrates an example of the association table in accordance with another embodiment of the disclosure;

FIG. 6 is a block diagram illustrating a configuration of a host controller in a display apparatus in accordance with another embodiment of the disclosure;

FIG. 7 illustrates an example of the association table in accordance with another embodiment of the disclosure;

FIG. 8 illustrates an example of the association table in accordance with another embodiment of the disclosure;

FIG. 9 illustrates an example of the association table in accordance with another embodiment of the disclosure;

FIG. 10 is a block diagram illustrating a configuration of a host controller in a display apparatus in accordance with another embodiment of the disclosure; and

FIG. 11 illustrates an example of the association table stored in the host controller.

### DESCRIPTION OF THE EMBODIMENTS

Embodiments of the disclosure are described below. For convenience of explanation, like elements are designated with like reference numerals and the discussion thereof is not duplicated.

### First Embodiment

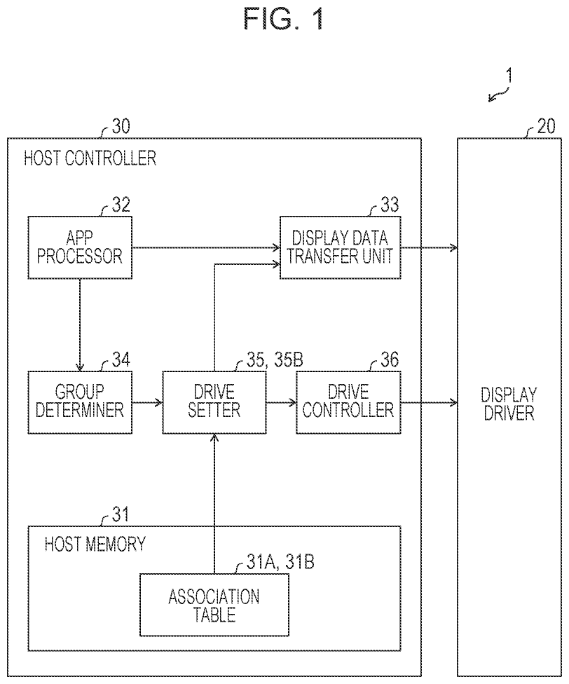

First embodiment of the disclosure is described with reference to FIGS. 1 through 4.

### Configuration of Display Apparatus 1

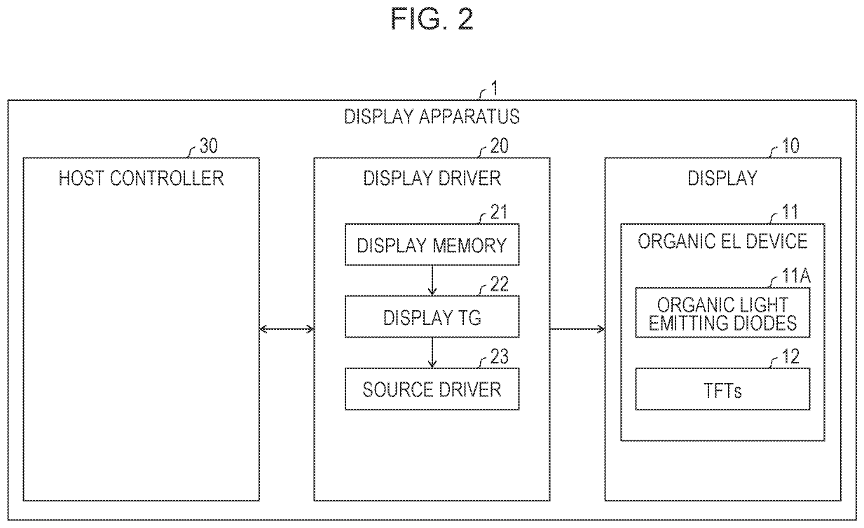

FIG. 2 is a block diagram illustrating a configuration of a display apparatus 1 (electronic apparatus) in accordance with the first embodiment of the disclosure. The display apparatus 1 includes a display 10, a display driver 20, and a host controller 30 (display control apparatus).

### Display 10

The display 10 displays an image. The display 10 includes a screen having a layout of organic electro-luminescent elements 11 (light-emitting elements), each including an organic light-emitting diode 11A. Images displayed on the display 10 include a still image and a video.

Display elements (light-emitting elements) included in the display 10 are electro-luminescent (EL) elements including organic light-emitting diodes 11A. While a liquid-crystal device is alternating-current (AC) driven, the organic EL element is not AC driven and is thus free from polarity reversal for a predetermined period of time. The organic EL element is less likely to suffer from characteristic shift, such as burn-in. The refresh rate of the images displayed on the display 10 may be reduced to about 0.0056 Hz (one update every about 3 minutes). A reduction in the refresh rate saves power (leading to a lower power consumption). The display elements of the display 10 may be inorganic EL elements that are electroluminescent elements manufactured of an inorganic material. The term refresh rate refers to a frequency of update of the display on the display 10 regardless of whether the contents of an image displayed on the display 10 change or not.

The display 10 may be an oxide semiconductor display panel as an active-matrix display panel. The oxide semiconductor display panel includes oxide semiconductor thin-film transistors (TFTs 12) employed for some or all of switching elements, each switching element placed for at least each of two-dimensionally arranged pixels. The oxide semiconductor TFT employs oxide semiconductor as a semiconductor layer. The oxide semiconductor of the first embodiment is manufactured of oxide semiconductors of indium (In), gallium (Ga), and zinc (Zn) (InGaZnO oxide semiconductor).

A current flowing through the oxide semiconductor TFT in an on-state is higher while the current flowing the oxide semiconductor TFT in an off-state is lower. The oxide semiconductor TFT has thus higher charge retention characteristic. With the oxide semiconductor TFT utilized for the switching element, a drop in display quality may be controlled even when the refresh rate of the image on the display 10 is reduced.

### Host Controller 30

The host controller 30 is utilized to control the display driver 20 and, for example, transfers updated display data for one screen to the display driver 20 when the display data is updated. The host controller 30 includes a control circuit formed on a substrate. Specifically, the host controller 30 may be a central processing unit (CPU), graphics processing unit (GPU), or a device including the CPU and GPU. The host controller 30 will be described below in greater detail.

### Display Driver 20

The display driver 20 drives the display 10 in response to an instruction from the host controller 30. For example, the display driver 20 may be a chip on glass (COG) driver where a driver is mounted on a glass substrate of the display 10 in a COG manner or may be a chip on flexible or chip on film (COF) driver where a driver is mounted on a flexible substrate of the display 10 in a COF manner. Alternatively, the display driver 20 may be a chip on plastic (COP) driver where a driver is mounted on a plastic substrate of the display 10 in a COP manner. The display driver 20 includes a display memory 21, a display timing generator (TG) 22, and a source driver 23.

The display memory 21 stores display data transferred from the host controller 30. The display memory 21 continues to store the display data until the display is updated (as long as the contents of the image displayed remains unchanged). The display memory 21 may be a video random-access memory (VRAM).

In response to an instruction from the host controller 30, the display TG 22 generates a timing signal driving the display 10 and supplies the timing signal to the source driver 23. In response to the timing signal supplied from the display TG 22, the source driver 23 writes a display voltage responsive to the display data onto pixels of the display 10.

Examples of the display apparatus 1 include display devices that particularly features portability, such as, cellular phones, smart phones, note-book personal computers (PCs), tablet terminals, e-book readers, wearable devices, personal digital assistants (PDAs). For example, a desktop PC may include a display that includes the display 10 and the display driver 20 and the host controller 30 may be included in a device (such as the body of the PC) different from the display. In such a case, the desktop PC falls within the scope of the disclosure.

### Detail of Host Controller 30

FIG. 1 is a block diagram illustrating the configuration of the host controller 30. The host controller 30 includes a host memory 31, an application (hereinafter referred to as “app”) processor 32 (image generator), a display data transfer unit 33 (display expander), a group determiner 34, a drive setter 35, and a drive controller 36.

The host memory 31 stores data to be processed by the host controller 30. For example, the host memory 31 may include a random-access memory (RAM), a read-only memory (ROM), a hard-disk drive (HDD), a solid-state drive (SSD), and/or a flash memory (registered trademark). The host memory 31 may be internal to the host controller 30 or may be externally connectable from the outside to the host controller 30. It is also noted that one or more host memories 31 are utilized in the display apparatus 1.

The app processor 32 is utilized to process application app software stored on the host memory 31. If a display screen on the display 10 is to be updated, the app processor 32 outputs to the display data transfer unit 33 display data including a screen to be displayed. The display data includes an image of a frame to be updated and a display update flag (time reference) indicating a timing of displaying the image. If the contents of the image remain unchanged across multiple frames, the image during the frames remaining unchanged may not necessarily be included in the display data.

The display data transfer unit 33 receives the display data from the app processor 32 and then transfers the display data to the display driver 20. In accordance with the display update flag included in the display data, the display data transfer unit 33 transfers the display data for an updating frame image to the display driver 20 only when the updating of the display on the display 10 is to be performed. The transfer of the display data may be performed in accordance with data communication specifications of mobile device, such as Mobile Industry Processor Interface (MIPI). The display data transfer unit 33 transfers a synchronization signal together with the display data to the display driver 20.

The display data transfer unit 33 expands or contracts the display data in accordance with a display resolution of the display 10 based on information on the resolution from the drive setter 35. For example, if the resolution of the display data is lower and the display resolution of the display 10 is higher, the display data transfer unit 33 expands the display data and then transfers the expanded display data to the display driver 20.

The group determiner 34 determines a web group, a game group, a video group, or a photograph group to which an app to be executed by the app processor 32 belongs to. According to the first embodiment, the apps are sorted into four groups, but the disclosure is not limited to the four groups. The apps may be sorted into five or more groups, or three or less groups. In order to make the determination, the group determiner 34 may utilize attribute information included in each app or association information that is pre-stored on the host memory 31 and indicates an association between each app and each group. The group determiner 34 notifies the drive setter 35 of the determination results.

In accordance with the determination results from the group determiner 34, the drive setter 35 sets a variety of drive parameters used to drive the display driver 20.

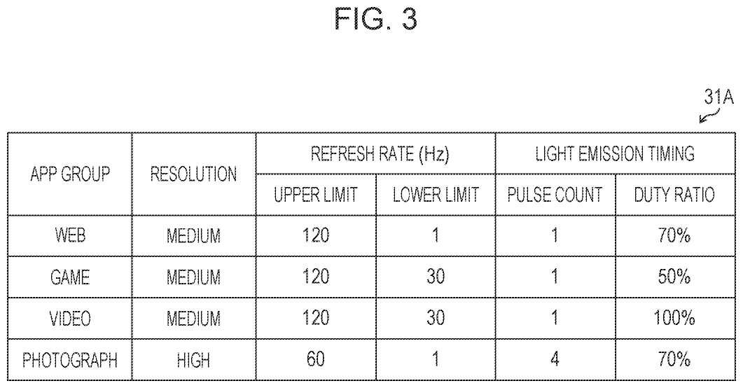

FIG. 3 illustrates an example of an association table 31A that indicates an association relationship between the app groups and the variety of drive parameters. The association table 31A is pre-stored on the host memory 31. By referencing the association table 31A in FIG. 3, the drive setter 35 sets the drive parameters corresponding to the app group determined by the group determiner 34. The drive setter 35 outputs the set drive parameters to the drive controller 36.

The drive controller 36 controls the display driver 20 in accordance with the drive parameter from the drive setter 35.

### Detail of Association Table 31A

Referring to FIG. 3, the app groups include the web group, the game group, the video group, and the photograph group. These groups are linked to drive parameters respectively appropriate for viewing the web, game, video, and photograph.

The drive parameters include a resolution (pixel count) of the display 10, an upper-limit value and a lower-limit value of the refresh rate, a pulse count indicating a light-emission timing during a panel scan period (reciprocal of the panel scan frequency), and a duty ratio. The light-emission timing with the pulse count being four and the duty ratio being 70% signifies that the organic EL device 11 emits light four times during the panel scan period and that an overall light-emission period to the panel scan period is 70%.

The panel scan period serves as a period used to refresh a display panel (the display 10) with image data for one frame. In other words, the panel scan period lasts from the start of displaying the image data for one frame to the end of displaying the image data for the one frame. The panel scan frequency is the reciprocal of the panel scan period. As the panel scan frequency becomes higher, display quality increases. However, the drive frequency of the display 10 also increases, leading to an increase in power consumption.

The upper-limit value and the lower-limit value of the refresh rate are respectively referred to as an upper-limit refresh rate and a lower-limit refresh rate.

If the resolution is higher, display definition is also higher. Photograph viewing may demand a higher display definition. The photograph group is thus associated with a higher resolution (for example, 2560×1440 pixels). On the other hand, typically, game viewing may not necessarily demand such a higher resolution. The game group is thus associated with a medium resolution (such as 1920×1080 pixels).

If the refresh rate is higher, operability and readability also increase. Web and game viewing demands operability and readability. The web and game groups are thus associated with a higher value as the upper-limit refresh rate (120 Hz in FIG. 3).

If a higher amount of display data at medium gradation is displayed, flickering is more likely to be recognized at a lower refresh rate. Games and videos have typically a higher amount of display data at the medium gradation. The game and video groups are associated with a higher value as the lower-limit refresh rate (30 Hz in FIG. 3). Since the amount of the display data at the medium gradation of the other groups are considered to be not so high, the other groups are associated with a lower value as the lower-limit refresh rate (1 Hz in FIG. 3).

A lower pulse count causes the afterimage on the retina to be reduced, leading to displaying a crisp image and thus improving readability. The web and game groups are thus associated with a lower pulse count (one pulse in FIG. 3).

A lower duty ratio causes the afterimage on the retina to be displayed at a smaller amount, thus leading to increased readability. The web and game groups are associated with a relatively lower duty ratio (70% and 50% in FIG. 3). With a higher duty ratio, display content is displayed at higher luminance. For example, the app group demanding higher luminance, such as a high dynamic range (HDR) video, may be associated with a relatively higher duty ratio (such as 100%).

The host controller 30 in the display apparatus 1 of the embodiment handles an app as a determination factor and identifies a set that is set in response to the termination element and includes an upper-limit refresh rate, a lower-limit refresh rate, and a duty ratio of light emission and controls the driving of the display apparatus 1 with the identified set. In response to the determination factor, the host controller 30 may thus limit the refresh rate, lower the refresh rate to the lower-limit refresh rate, and set the duty ratio of light emission. As a result, the maintenance of the display quality and power saving (with lower power consumed) may be addressed.

The driving of the display apparatus 1 is controlled in accordance with the set appropriate for the app. Improvement of the display quality and power saving may be addressed in a manner free from performing any complex operation.

Since the set includes the pulse count of light emission during the panel scan period, the driving of the display apparatus 1 is controlled with the pulse count responsive to the determination factor. The driving of the display apparatus 1 is controlled in accordance with the set appropriate for the app. In this way, improvement of the display quality and power saving may be further addressed.

The set includes the resolution of a display image. In response to the determination factor, the resolution of the display image is identified, and display image data is generated at the resolution and is expanded to the display resolution of the display apparatus 1. A display image is thus displayed at the resolution responsive to the determination factor on the display apparatus 1. In this way, improvement of the display quality and power saving may be further addressed.

### Display Control Method

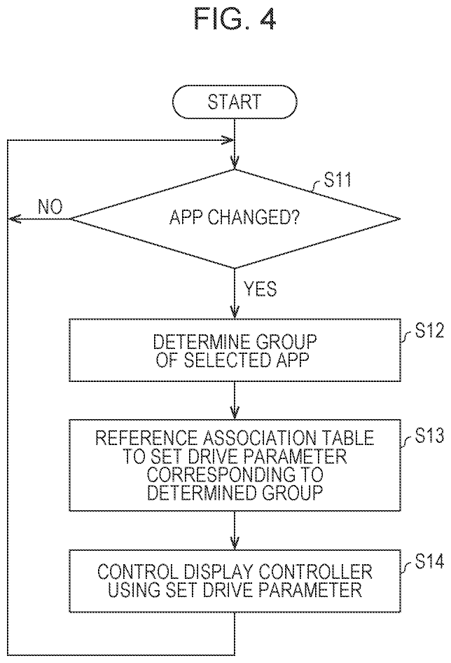

FIG. 4 is a flowchart illustrating an example of a flow of a drive control process performed by the host controller 30 in the display apparatus 1 described above.

Referring to FIG. 4, the host controller 30 waits until apps (apps displaying an image on the display 10) to be performed by the app processor 32 are changed (S11). After changing apps, the group determiner 34 determines the group to which an app as a result of change belongs (S12). The drive setter 35 sets drive parameters responsive to the determined group by referencing the association table 31A stored on the host memory 31 (S13 as a drive setting step). The drive controller 36 controls the display driver 20 using the set drive parameters (S14 as a drive control step). Processing returns to step S11 to iterate the process described above.

### Remarks

According to the first embodiment, the association table 31A associates a variety of drive parameters with each group of apps. Alternatively, the association table 31A may associate the drive parameters with each app. In such a case, the group determiner 34 may be omitted.

The association table 31A may be modified by a user. In such a case, the user may set the display quality to the user's own preference.

The duty ratio may be higher than 50% and lower than 100%. In such a case, a reduction in degradation of the display quality (for example, color breaking) and reduction of the afterimage on the retina may be addressed at the same time.

### Second Embodiment

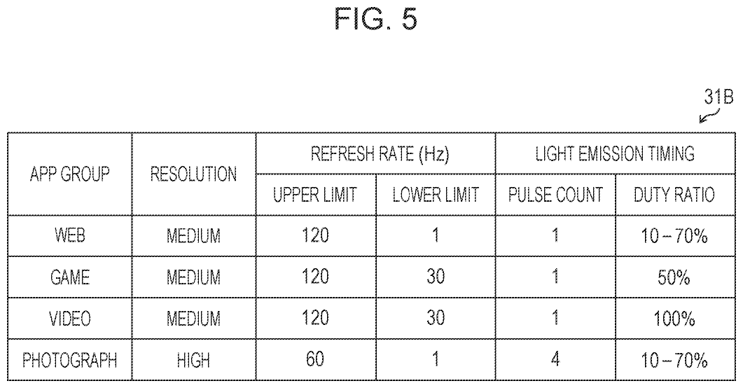

Second embodiment of the disclosure may be described with reference to FIGS. 1 and 5. The difference between the display apparatus 1 of the second embodiment and the display apparatus 1 of the first embodiment described with reference to FIGS. 1 through 4 lies in that the display apparatus 1 of the second embodiment includes an association table 31B and drive setter 35B respectively in place of the association table 31A and drive setter 35. The rest of the display apparatus 1 is identical to the first and second embodiments.

FIG. 5 illustrates an example of the association table 31B in accordance with the second embodiment. The difference between the association table 31B in FIG. 5 between the association table 31A in FIG. 3 lies in that the association table 31B lists the duty ratio of light emission not only by a given value on a per group basis but by a range of value on a per group basis. The rest of the association table 31B is identical to the association table 31A. Referring to FIG. 5, a duty ratio in the range of 10% to 70% is associated with the web and photograph groups.

The difference between the drive setter 35B and the drive setter 35 in FIGS. 1 and 4 lies in that if the duty ratio associated with the determined group falls within the above-described range, the drive setter 35B further sets a duty ratio from within the above-described range in accordance with the luminance acquired from the drive controller 36. The rest of the operation of the drive setter 35B is identical to the operation of the drive setter 35.

With the duty ratio variable, the reduction of the afterimage on the retina and improvement in the display quality at lower luminance may be addressed.

### Third Embodiment

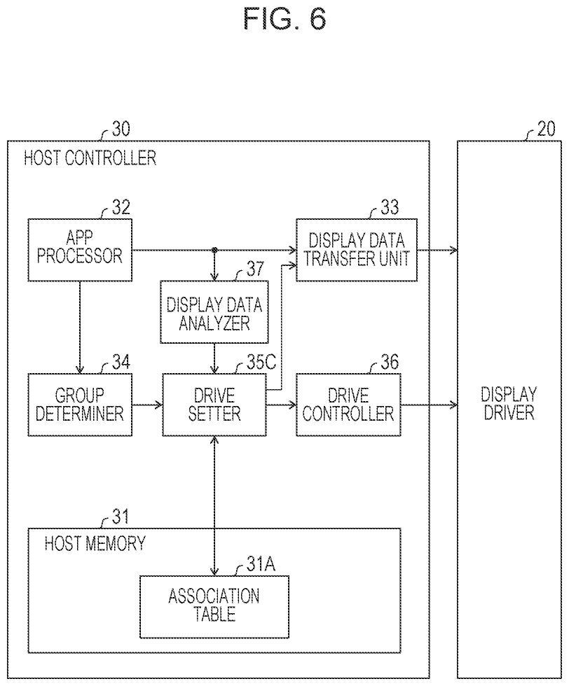

Third embodiment of the disclosure is described below with reference to FIG. 6. The difference between the display apparatus 1 of the third embodiment and the display apparatus 1 in FIGS. 1 through 4 lies in the configuration of the host controller 30. The rest of the display apparatus 1 of the third embodiment is identical to the display apparatus 1 of the first embodiment.

FIG. 6 is a block diagram illustrating the configuration of the host controller 30 in the display apparatus 1 of the third embodiment. The difference between the host controller 30 in FIG. 6 and the host controller 30 in FIG. 1 lies in that the host controller 30 in FIG. 6 additionally includes an display data analyzer 37 and a drive setter 35C in place of the drive setter 35. The rest of the host controller 30 in FIG. 6 is identical to the host controller 30 in FIG. 1.

The display data analyzer 37 analyzes display data from the app processor 32 to create a frequency distribution of display gradation (image content). The display data analyzer 37 outputs the created frequency distribution of display gradation to the drive setter 35C.

The difference between the drive setter 35C and the drive setter 35 in FIG. 1 lies in that the drive setter 35C updates the lower-limit refresh rate in the association table 31A in accordance with the frequency distribution of the display gradation from the display data analyzer 37. The rest of the drive setter 35C is identical to the drive setter 35.

In the configuration described above, the host controller 30 appropriately updates the lower-limit refresh rate in accordance with a display image. If the display image includes a higher amount of display data at a gradation likely to suffer from flickering, the lower-limit refresh rate may be increased. The refresh rate may thus be reduced to a level that allows the display quality to be kept. As a result, the maintenance of the display quality and power saving may be addressed at the same time.

### Fourth Embodiment

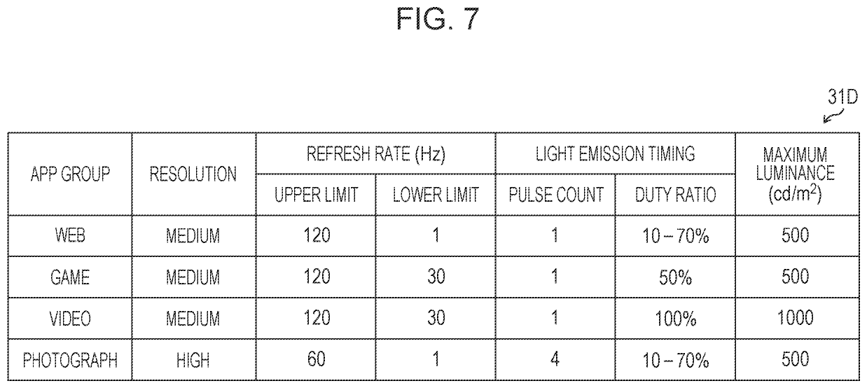

Fourth embodiment of the disclosure is described with reference to FIG. 7. The difference between the display apparatus 1 of the fourth embodiment and the display apparatus 1 in FIGS. 1 and 5 lies in that the display apparatus 1 of the fourth embodiment has the association table 31D in place of the association table 31B. The rest of the display apparatus 1 of the fourth embodiment is identical to the display apparatus 1 in FIGS. 1 and 5.

FIG. 7 illustrates an example of the association table 31D in accordance with the fourth embodiment. The difference between the association table 31D in FIG. 7 and the association table 31B in FIG. 5 lies in that the association table 31D additionally includes maximum luminance (cd/m²) as a drive parameter. The rest of the association table 31D is identical to the association table 31B.

Referring to FIG. 7, a higher maximum luminance (1000 cd/m²) is associated with the video group. In this way, displaying is performed with higher priority placed on luminance on a video app, demanding higher luminance, such as a high dynamic range (HDR) video. As a result, higher quality displaying may thus be provided.

### Fifth Embodiment

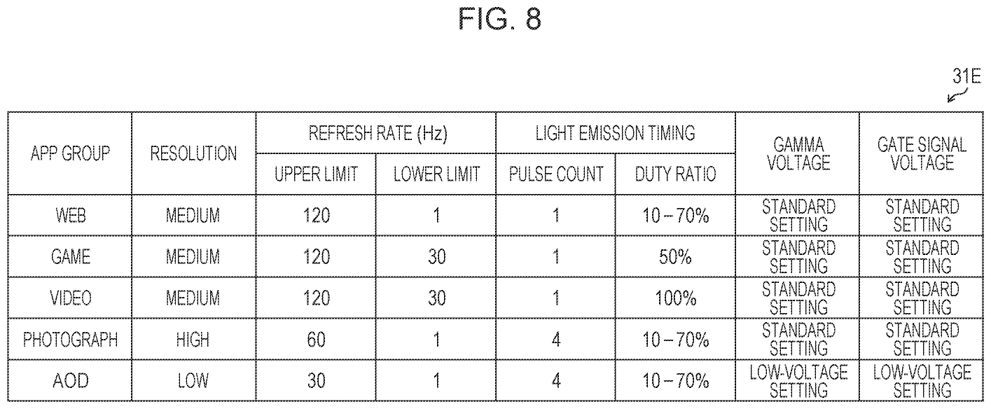

Fifth embodiment of the disclosure is described with reference to FIG. 8. The difference between the display apparatus 1 of the fifth embodiment and the display apparatus 1 of the second embodiment in FIGS. 1 and 5 lies in that the display apparatus 1 of the fifth embodiment has an association table 31E in place of the association table 31B. The rest of the display apparatus 1 of the fifth embodiment is identical to the display apparatus 1 of the second embodiment in FIGS. 1 and 5.

FIG. 8 illustrates an example of the association table 31E of the fifth embodiment. The difference between the association table 31E in FIG. 8 and the association table 31B in FIG. 5 lies in that the association table 31E additionally includes a group of Always On Display (AOD) and, as drive parameters, a gamma (γ) voltage (display control voltage) and a gate signal voltage (display control voltage). The rest of the association table 31E is identical to the association table 31B.

AOD is an app that displays limited information on a smart phone in sleep mode. The gamma voltage and gate signal voltage are applied to the display 10. The gamma voltage correlates with a luminance value on the screen of the display 10 and the correlation is determined based on characteristics of the display 10. The gate signal voltage is determined based on the characteristics of the display 10.

Referring to FIG. 8, the resolution, the upper-limit refresh rate and the lower-limit refresh rate are set to be lower in the drive parameters in the AOD group than in the other groups. The AOD group has a higher pulse count, a duty ratio within a range of 10 to 70%, and a gamma voltage and a gate signal voltage set to constant values. If the display content is limited as in the AOD group, the drive parameters may be set to be lower than in the other apps within a range that does not affect the display quality. As a result, further power saving may be addressed.

### Sixth Embodiment

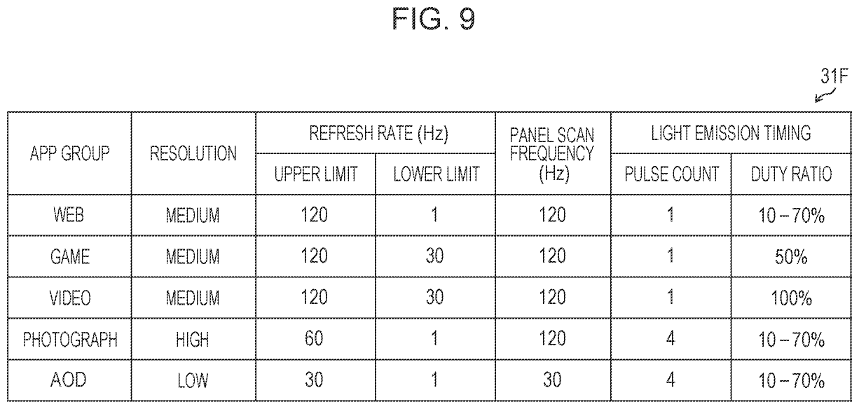

Sixth embodiment of the disclosure is described with reference to FIG. 9. The difference between the display apparatus 1 of the sixth embodiment and the display apparatus 1 of the fifth embodiment in FIG. 8 lies in that the display apparatus 1 of the sixth embodiment has an association table 31F in place of the association table 31E. The rest of the display apparatus 1 of the sixth embodiment is identical to the display apparatus 1 of the fifth embodiment in FIG. 8.

FIG. 9 illustrates an example of the association table 31F of the sixth embodiment. The difference between the association table 31F in FIG. 9 and the association table 31E in FIG. 8 lies in that the association table 31F includes as a drive parameter a panel scan frequency (Hz) in place of the gamma voltage and gate signal voltage. The rest of the association table 31F is identical to the association table 31E.

Referring to FIG. 9, the panel scan frequency is set to be lower in the AOD group than in the other groups. If the display content is limited as in the AOD group, the panel scan frequency may be set to be lower than in the other apps within a range that does not affect the display quality. As a result, power saving may be further addressed in a way similar to the fifth embodiment in FIG. 8.

### Seventh Embodiment

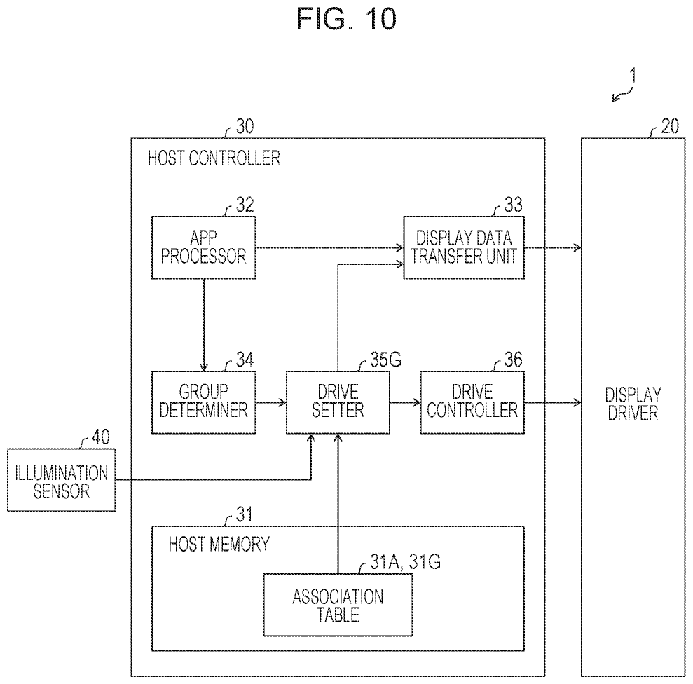

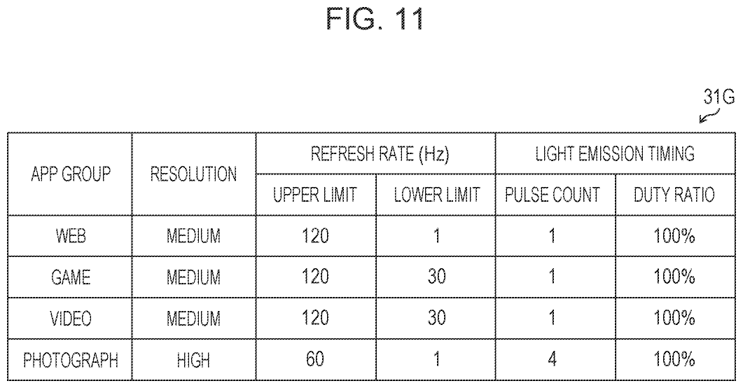

Seventh embodiment of the disclosure is described with reference to FIGS. 10 and 11. The difference between the display apparatus 1 of the seventh embodiment and the display apparatus 1 of the first embodiment in FIGS. 1 through 4 lies in that the display apparatus 1 of the seventh embodiment includes additionally an illumination sensor 40 and a host controller 30 having a different configuration. The rest of the display apparatus 1 of the seventh embodiment is identical to the display apparatus 1 of the first embodiment in FIGS. 1 through 4.

FIG. 10 is a block diagram illustrating the configuration of the host controller 30 in the display apparatus 1 of the seventh embodiment. The difference between the host controller 30 in FIG. 10 and the host controller 30 in FIG. 1 lies in that the host controller 30 in FIG. 1 newly has an association table 31G and includes a drive setter 35G in place of the drive setter 35. The rest of the host controller 30 in FIG. 10 is identical to the host controller 30 in FIG. 1.

The illumination sensor 40 detects an intensity of ambient illumination of the display apparatus 1. The illumination sensor 40 outputs data on the detected illumination to the drive setter 35G in the host controller 30. The illumination sensor 40 may not necessarily be installed in the display apparatus 1 but may be installed external to the display apparatus 1.

FIG. 11 illustrates an example of the association table 31G of the seventh embodiment. The difference between the association table 31G in FIG. 11 and the association table 31A in FIG. 3 lies in that the association table 31G has a maximum duty ratio (100%) in each of the groups. The rest of the association table 31G is identical to the association table 31A.

The difference between the drive setter 35G and the drive setter 35 in FIG. 1 lies in that the drive setter 35G selects between the association table 31A and the association table 31G in response to the illumination data from the illumination sensor 40 and uses the selected association table. The rest of the drive setter 35B is identical to the drive setter 35. Specifically, the drive setter 35G selects the association table 31G if the illumination is higher or the association table 31A if the illumination is not higher.

A luminance component on the display 10 may be increased in outdoor environments where illumination is typically higher. According to the seventh embodiment, the duty ratio is set to be higher in a high-illumination environment. Clear displaying may thus be provided in the high-illumination environment. The association tables may be changed in response to the environment of the display apparatus 1.

### Modifications

The association tables may be changed in view of the status of the display apparatus 1. For example, the display apparatus 1 may now operate on a rechargeable battery at a lower battery level. In such a case, the drive setter 35G may switch to an association table for a power-saving version to continue to operate.

### Implementation Via Software

The function of the display apparatus 1 (hereinafter referred to as an apparatus) may be implemented by a program causing a computer to perform the function of the apparatus. The program thus causes the computer to operate as control blocks of the apparatus (particularly, blocks included in the host controller 30)

The apparatus is a computer including at least one control device (such as a processor) as hardware executing the program and at least a storage device (such as a memory). The control device and storage device execute the program, thus performing the functions of each of the embodiments described above.

The program may be stored on one or more non-transitory computer-readable recording media. The apparatus may or may not include the recording medium. If the apparatus does not include the recording medium, the program may be delivered to the apparatus via any wired or wireless transmission medium.

Part or whole of the function of each control block may be implemented using a logic circuit. For example, an integrated circuit where a logic circuit functioning as each control block is formed may fall within the scope of the disclosure. The function of each control block may be implemented by a quantum computer.

Each process described with reference to the embodiments may be performed by artificial intelligence (AI). The AI may operate on the control device or any other device (such as an edge computer or a cloud server).

### CONCLUSIONS

According to a first aspect of the disclosure, there is provided a display control apparatus (the host controller 30) controlling a display apparatus (the display apparatus 1) including light-emitting elements. The display control apparatus includes: a drive setter (the drive setter 35, 35B, 35C, or 35G) that identifies a set that includes an upper-limit refresh rate, a lower-limit refresh rate, and a duty ratio of light emission and is set in response to at least one determination factor selected from the group consisting of an app, an intensity of illumination, a remaining battery level, and an image content; and a drive controller (the drive controller 36) that controls driving of the display apparatus in accordance with the identified set.

In the configuration described above, the set including the upper-limit refresh rate, the lower-limit refresh rate, and the duty ratio of the light emission is set in response to the determination factor is identified and the driving of the display apparatus is controlled at the identified set. The refresh rate may be limited in response to the determination factor or reduced to the lower-limit refresh rate, and the duty ratio of the light emission may be set. As a result, the maintenance of the display quality and power saving may be addressed.

According to a second aspect of the disclosure in view of the first aspect, the determination factor may include the app.

Specifically, the drive setter may identify, in response to a first app, a set of a first upper-limit refresh rate, a first lower-limit refresh rate, and a first duty ratio, and may identify, in response to a second app, a set of a second upper-limit refresh rate lower than the first refresh rate, a second lower-limit refresh rate lower than the first lower-limit refresh rate, and a second duty ratio higher than the first duty ratio.

In the configuration described above, the driving of the display apparatus is controlled in accordance with the set appropriate for the app. The maintenance of the display quality and power saving may be addressed in a manner from performing any complex operation.

According to a third aspect of the disclosure in view of the first and second aspects, the drive setter may identify, in response to the determination factor, a pulse count of light emission during a panel scan period that lasts to refresh a display panel with image data of one frame and the drive controller may control the driving of the display apparatus in accordance with the pulse count.

In the configuration described above, the driving of the display apparatus is controlled in accordance with the pulse count responsive to the determination factor. The maintenance of the display quality and power saving may be further addressed.

According to a fourth aspect of the disclosure in view of the first through third aspects, the drive setter may include: an image generator (the app processor 32) that identifies the resolution of a display image in response to the determination factor and generates display image data at the resolution; and a display expander (the display data transfer unit 33) that expands the display image data at the resolution to a display resolution of the display apparatus.

In the configuration described above, the display image is displayed at the resolution responsive to the determination factor on the display apparatus. The maintenance of the display quality and power saving may be further addressed.

According to a fifth aspect of the disclosure in view of the first through fourth aspects, the drive setter may identify a display control voltage in response to the determination factor, and the drive controller may control the driving of the display apparatus in accordance with the display control voltage.

In the configuration described above, the driving of the display apparatus is controlled by the display control voltage responsive to the determination factor. The maintenance of the display quality and power saving may be further addressed.

According to a sixth aspect of the disclosure in view of the first through fifth aspects, the drive setter may identify, in response to the determination factor, maximum luminance of each pixel of the display apparatus and the drive controller may control the driving of the display apparatus in accordance with the maximum luminance.

In the configuration described above, the driving of the display apparatus is controlled in accordance with the maximum luminance responsive to the determination factor. The maintenance of the display quality and power saving may be further addressed.

According to a seventh aspect of the disclosure in view of the first through sixth aspects, the drive setter may identify, in response to the determination factor, a panel scan period that lasts to refresh image data of one frame and the drive controller may control the driving of the display apparatus during the panel scan period.

In the configuration described above, the driving of the display apparatus is controlled during the panel scan period responsive to the determination factor. The maintenance of the display quality and power saving may be further addressed.

The determination factor may include the intensity of illumination and/or the remaining battery level. In such a case, the maintenance of the display quality and power saving may be addressed in a manner free from performing any complex operation.

According to an eighth aspect of the disclosure in view of the first through seventh aspects, in the display control apparatus, the determination factor may include the image content and the set may be updated in accordance with the image content.

The set may thus be modified such that the modified set is appropriate for the image content. The maintenance of the display quality and power saving may be further addressed.

According to a ninth aspect of the disclosure in view of the first through eighth aspects, in the display control apparatus, the duty ratio is 50% or higher and 100% or lower. Reduction in degradation (such as color breaking) in the display quality and reduction in the afterimage on the retina may be addressed at the same time.

According to a tenth aspect of the disclosure in view of the first through ninth aspects, in the display control apparatus, the drive setter may set so that a value of the lower-limit refresh rate in a case of which the determination factor indicates a higher amount of display data at a medium gradation is higher than a value of the lower-limit refresh rate in a case of which the determination factor indicates a lower amount of the display data at the medium gradation. The maintenance of the display quality and power saving may be addressed at the same time.

According to an eleventh aspect of the disclosure, there is provided an electronic apparatus including the display control apparatus and the display apparatus including the light-emitting element according to the first through tenth aspects. The maintenance of the display quality and power saving may be addressed.

According to a twelfth aspect of the disclosure, there is provided a display control method controlling a display apparatus including light-emitting elements. The display control method includes: identifying a set that includes an upper-limit refresh rate, a lower-limit refresh rate, and a light emission duty ratio and is set in response to at least one determination factor selected from the group consisting of an app, an intensity of illumination, a remaining battery level, and an image content; and controlling driving of the display apparatus in accordance with the identified set.

The display control apparatus according to each of the aspects of the disclosure may be implemented by a computer. In such a case, a control program of the display control apparatus causes the computer to operate as each element (software element) of the display control apparatus and thus causes the computer to operate as the display control apparatus. Such a computer program and a computer-readable recording medium having stored the computer program fall within the scope of the disclosure.

The disclosure is not limited to the embodiments described above. A variety of changes is possible within the scope of the disclosure defined by the appended claims. A combination of techniques disclosed in the different embodiments may fall within the scope of the disclosure. Furthermore, a new technical feature may be formed by combining the techniques disclosed in the embodiments.

The present disclosure contains subject matter related to that disclosed in Japanese Priority Patent Application JP 2021-079366 filed in the Japan Patent Office on May 7, 2021, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display control apparatus controlling a display apparatus having light-emitting elements, the display control apparatus comprising:
a drive setter that identifies a set that includes an upper-limit refresh rate, a lower-limit refresh rate, and a duty ratio of light emission and is set in response to at least one determination factor selected from the group consisting of an application, an intensity of illumination, a remaining battery level, and an image content; and
a drive controller that controls driving of the display apparatus in accordance with the identified set.

2. The display control apparatus according to claim 1, wherein the drive setter identifies, in response to the determination factor, a pulse count of light emission during a panel scan period that lasts to refresh a display panel with image data of one frame and
wherein the drive controller controls the driving of the display apparatus in accordance with the pulse count.

3. The display control apparatus according to claim 1, wherein the drive setter comprises:
an image generator that identifies a resolution of a display image in response to the determination factor and generates display image data at the resolution; and
a display expander that expands the display image data at the resolution to a display resolution of the display apparatus.

4. The display control apparatus according to claim 1, wherein the drive setter identifies a display control voltage in response to the determination factor, and
wherein the drive controller controls the driving of the display apparatus in accordance with the display control voltage.

5. The display control apparatus according to claim 1, wherein the drive setter identifies a maximum luminance of each pixel in the display apparatus in response to the determination factor; and
wherein the drive controller controls the driving of the display apparatus in accordance with the maximum luminance.

6. The display control apparatus according to claim 1, wherein the drive setter identifies, in response to the determination factor, a panel scan period that lasts to refresh image data of one frame; and
wherein the drive controller controls the driving of the display apparatus during the panel scan period.

7. The display control apparatus according to claim 1, wherein the duty ratio is 50% or higher and 100% or lower.

8. The display control apparatus according to claim 1, wherein the drive setter sets so that a value of the lower-limit refresh rate in a case of which the determination factor indicates a higher amount of display data at a medium gradation is higher than a value of the lower-limit refresh rate in a case of which the determination factor indicates a lower amount of the display data at the medium gradation.

9. An electronic apparatus comprising the display control apparatus and the display apparatus, including the light-emitting element, according to claim 1.

10. A non-transitory computer-readable recording medium in which a control program causing a computer to operate as the display control apparatus according to claim 1, wherein the control program causes the computer to operate as the drive setter and the drive controller.

11. A display control method controlling a display apparatus having light-emitting elements, the display control method comprising:
identifying a set that includes an upper-limit refresh rate, a lower-limit refresh rate, and a light emission duty ratio and is set in response to at least one determination factor selected from the group consisting of an application, an intensity of illumination, a remaining battery level, and an image content; and
controlling driving of the display apparatus in accordance with the identified set.
